(19) United States
(12) Patent Application Publication
(10) Pub. No.: US 2018/0258872 A1
(43) Pub. Date: Sep. 13, 2018

(54) CONTROL DEVICE FOR INTERNAL COMBUSTION ENGINE AND METHOD FOR CONTROLLING INTERNAL COMBUSTION ENGINE

(71) Applicant: HONDA MOTOR CO., LTD., Tokyo (JP)

(72) Inventors: Masaya AGATA, Wako (JP); Masayoshi NISHINO, Wako (JP); Takaaki FUKUSAKO, Wako (JP)

(73) Assignee: HONDA MOTOR CO., LTD., Tokyo (JP)

(21) Appl. No.: 15/884,379

(22) Filed: Jan. 31, 2018

(30) Foreign Application Priority Data
Mar. 13, 2017 (JP) 2017-047135

(51) Int. Cl. F02D 41/00; F02D 41/40; F02D 41/18; F02D 11/10; F02D 13/02

(52) U.S. Cl. CPC F02D 41/0072; F02D 41/401; F02D 41/182; F02D 11/105; F02D 2250/18; F02D 2041/002; F02D 2200/0402; F02D 2200/0404; F02D 2200/0604; F02D 13/0253

(57) ABSTRACT

A control device for an internal combustion engine includes a throttle valve actuator and circuitry. The circuitry is configured to calculate, based on a target intake air amount, a target recirculated amount of recirculated exhaust gas that is recirculated to an intake passage through an exhaust gas recirculation device, calculate a corrected target recirculated amount based on the target recirculated amount and an exhaust gas recirculated amount change delay in a change in a recirculated amount of the recirculated exhaust gas, calculate a target intake pressure based on the target intake air amount and the corrected target recirculated amount, calculate a target opening degree of the throttle valve based on the target intake air amount and the target intake pressure, and control the throttle valve actuator to drive the throttle valve such that an opening degree of the throttle valve is to be equal to the target opening degree.

### CROSS-REFERENCE TO RELATED APPLICATIONS

The present application claims priority under 35 U. S. C. § 119 to Japanese Patent Application No. 2017-047135, filed Mar. 13, 2017. The contents of this application are incorporated herein by reference in their entirety.

### BACKGROUND

### 1. Field

The present invention relates to a control device for an internal combustion engine and a method for controlling an internal combustion engine.

### 2. Description of the Related Art

Japanese Patent No. 4415509 discloses a control device for an internal combustion engine intended to enhance the control accuracy of an actual intake airflow corresponding to a target torque even when there is the dispersion in the characteristics on the relationship between the opening and intake airflow of a throttle valve of the internal combustion engine. According to this control device, a target intake airflow is calculated based on the target torque and a target intake pressure is calculated based on a target intake airflow, a recirculation outlet flow and the like, wherein a target opening of the throttle valve is calculated based on the target intake pressure and the target intake airflow without using the actual intake pressure and the actual throttle valve opening is controlled to correspond to the target opening.

### SUMMARY

According to one aspect of the present invention, a control device for an internal combustion engine provided with an exhaust gas recirculation device (an EGR device) adapted to recirculate exhaust gas to an intake passage includes target opening calculating means for calculating a target opening of a throttle valve housed in the intake passage and throttle valve driving means for driving the throttle valve so that the actual opening of the throttle valve corresponds to the target opening. The control device further includes target torque calculating means for calculating a target torque of the engine, target intake airflow calculating means for calculating a target intake airflow of the engine based on the target torque; and target intake pressure calculating means for calculating a target intake pressure based on the target intake airflow. The target intake pressure calculating means calculates the target intake pressure by performing an intake pressure change delay process corresponding to a change delay of recirculated exhaust flow that is a flow of exhaust to be recirculated through the exhaust gas recirculation device. The target opening calculation means calculates the target opening using the target intake airflow and the target intake pressure.

According to another aspect of the present invention, a control device for an internal combustion engine, includes a throttle valve actuator to drive a throttle valve provided in an intake passage in the internal combustion engine; and circuitry. The circuitry is configured to calculate a target torque to be generated by the internal combustion engine, calculate a target intake air amount of the internal combustion engine based on the target torque, calculate, based on the target intake air amount, a target recirculated amount of recirculated exhaust gas that is recirculated to the intake passage through an exhaust gas recirculation device of the internal combustion engine, calculate a corrected target recirculated amount based on the target recirculated amount and an exhaust gas recirculation amount change delay in a change in a recirculated amount of the recirculated exhaust gas, calculate a target intake pressure based on the target intake air amount and the corrected target recirculated amount, calculate a target opening degree of the throttle valve based on the target intake air amount and the target intake pressure, and control the throttle valve actuator to drive the throttle valve such that an opening degree of the throttle valve is to be equal to the target opening degree.

According to a further aspect of the present invention, a method for controlling an internal combustion engine, includes calculating a target torque to be generated by the internal combustion engine, calculating a target intake air amount of the internal combustion engine based on the target torque, calculating, based on the target intake air amount, a target recirculated amount of recirculated exhaust gas that is recirculated to an intake passage in the internal combustion engine through an exhaust gas recirculation device of the internal combustion engine, calculating a corrected target recirculated amount based on the target recirculated amount and an exhaust gas recirculated amount change delay in a change in a recirculated amount of the recirculated exhaust gas, calculating a target intake pressure based on the target intake air amount and the corrected target recirculated amount, calculating a target opening degree of a throttle valve provided in the intake passage based on the target intake air amount and the target intake pressure, and driving the throttle valve such that an opening degree of the throttle valve is to be equal to the target opening degree.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a view showing an internal combustion engine and a constitution of its control device according to one embodiment of the present invention;

FIG. 2 is a time chart for explaining the problems to be solved by the embodiment;

FIG. 3 is a time chart for explaining a control method of the embodiment;

FIG. 4 is a process flowchart for performing an output torque control of the internal combustion engine;

FIG. 5 is a process flowchart for calculating a target intake pressure (PBACMD) in the process of FIG. 4;

FIGS. 6A to 6D are views for explaining a map or a table referred in the process of FIG. 4 or FIG. 5;

FIGS. 7A to 7E are views for explaining a rate limit processing in the direction of increase executed in the processing of FIG. 5; and

FIG. 8 is a time chart for explaining the variation of the present embodiment.

### DESCRIPTION OF THE EMBODIMENTS

The embodiments will now be described with reference to the accompanying drawings, wherein like reference numerals designate corresponding or identical elements throughout the various drawings.

Preferred embodiments of the present invention will now be described below referring to the accompanying drawings.

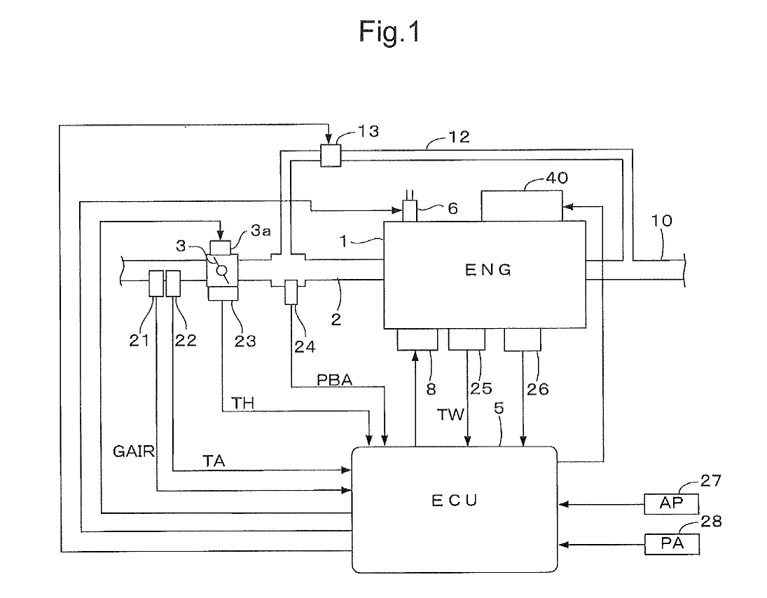

FIG. 1 is view showing an internal combustion engine and a constitution of its control device according to one embodiment of the present invention and an internal combustion engine 1 (hereinafter referred to as “engine”) shown in this figure has, for example, four cylinders and each cylinder is provided with an injector 6 injecting fuel directly into a combustion chamber. The operation of the injector 6 is controlled by an electronic control unit 5 (hereinafter referred to as “ECU”). Also, each cylinder of the engine 1 is provided with a spark plug 8 and the ignition timing by the spark plug 8 is controlled by the ECU 5. A throttle valve 3 is allocated in an intake passage 2 of the engine 1.

Connected to the ECU are an intake airflow sensor 21 for detecting an intake airflow GAIR (an intake air amount GAIR) if the engine 1, an intake air temperature sensor 22 for detecting an intake air temperature TA, a throttle valve opening sensor 23 for detecting a throttle valve opening TH (an opening degree TH), an intake pressure sensor 24 for detecting an intake pressure PBA, a cooling water temperature sensor 25 for detecting engine cooling water temperature TW, a crank angle position sensor 26 for detecting a rotation angle of a crank shaft (not shown) of the engine 1, an accelerator sensor 27 for detecting an accelerator pedal operation amount AP of a vehicle driven by the engine 1, an atmospheric pressure sensor 28 for detecting an atmospheric pressure PA, and other sensors (not shown) (e.g., an air-fuel ratio detection sensor for detecting an air-fuel ratio AF, a cam angle sensor for detecting the rotation angle of a cam shaft, a vehicle speed sensor, etc.) and detection signals by these sensors are supplied to the ECU 5. The crank angle position sensor 26 is provided to output a plurality of pulse signals showing a crank angle position and this pulse signal is used for various sorts of timing control such as fuel injection timing and ignition timing, and for detection of an engine speed (engine rotation speed) NE.

The engine 1 is provided with an exhaust gas recirculation device (an EGR device) and this EGR device has an exhaust gas recirculation passage (an EGR passage) 12 for connecting an exhaust passage 10 and an intake passage 2 and an exhaust gas recirculation valve 13 (hereinafter referred to as “EGR valve”) to control exhaust airflow (air amount) passing through the EGR passage 12. The operation of the EGR valve 13 is controlled by the ECU 5.

The engine 1 is provided with a valve operating characteristic variable device 40 capable of continuously changing an operation phase CAIN of an intake valve (not shown) provided in each cylinder and an intake valve operation phase CAIN is controlled by the ECU 5.

The ECU 5 has a known structure provided with a CPU, a memory, an input/output circuit, etc. and performs, according to the operation state of the engine (mainly, the engine speed NE and the target torque TRQCMD), a fuel injection control by the injector 6, an ignition timing control by the spark plug 8, an intake airflow control (an intake air amount control) by an actuator 3a and the throttle valve 3, an exhaust gas recirculation flow control (an EGR flow control) by the EGR valve 13, and an intake valve operation phase control by the valve operating characteristic variable device 40. The target torque TRQCMD is calculated mainly according to the accelerator pedal operation amount AP and is made larger as the accelerator pedal operation amount AP increases. Also, the target intake airflow GAIRCMD (the target intake air amount GAIRCMD) is calculated according to the target torque TRQCMD and calculated to be approximately proportional to the target torque TRQCMD. The intake airflow control that drives the throttle valve 3 by the actuator 3a is performed so that the actual intake airflow GAIR corresponds to the target intake airflow GAIRCMD.

A fuel injection amount (mass) GINJ by the injector 6 is controlled by correcting a basic fuel amount GINJB calculated using the intake airflow GAIR using a correction factor such as an air-fuel correction factor KAF according to the air-fuel ratio AF detected by the air-fuel ratio detection sensor. Meanwhile, the fuel injection amount GINJ is, using a publicly known method, converted into an opening valve time TOUT of the injector 6 according to a fuel pressure PF, a fuel density and the like and is controlled so that a fuel amount to be supplied into the combustion chamber per one cycle becomes the fuel injection amount GINJ.

The ECU 5 is connected to an electronic control unit for transmission control (transmission control ECU, not shown) for controlling a transmission of a vehicle driven by the engine 1 through a network bus and in the case of upshift and downshift, performs cooperative control for changing a target torque TRQCMD according to a torque change request from the transmission control ECU.

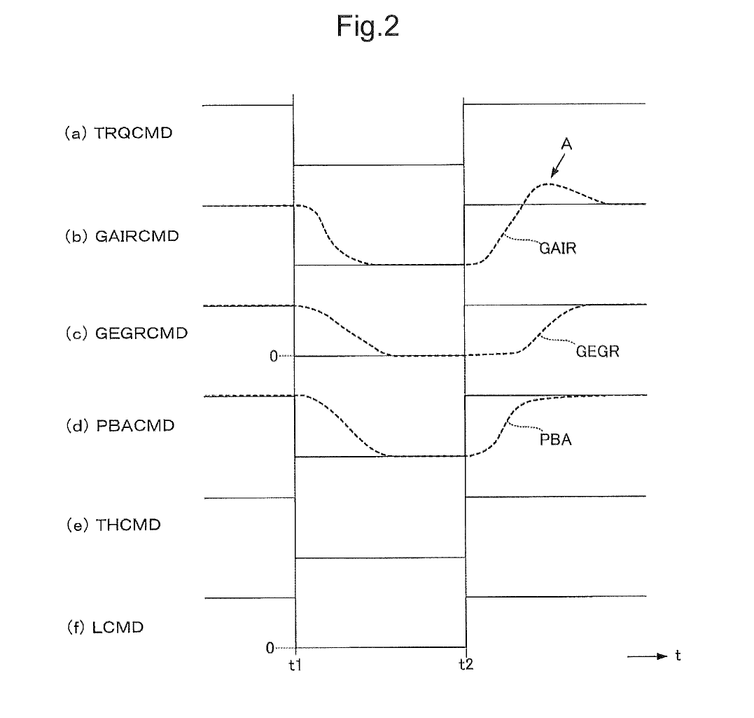

FIG. 2 is a time chart for explaining the problems to be solved by the embodiment and shows a transition of target torque TRQCMD, target intake airflow GAIRCMD (target intake air amount GAIRCMD), target recirculated exhaust gas flow (hereinafter referred to as “target EGR flow”) GEGRCMD (target recirculation amount GEGRCMD), target intake pressure PBACMD, and target lift amount LCMD corresponding to target opening THCMD (target opening degree THCMD) of the throttle valve 3 and target opening (target opening degree) of EGR valve 13. Broken lines shown in (b), (c) and (d) of FIG. 2 show a transition of the actual intake airflow GAIR, recirculate exhaust gas flow GEGR (recirculation amount GEGR), and intake pressure PBA.

In the present embodiment, target intake airflow GAIRCMD is calculated based on target torque TRQCMD, target EGR flow GEGRCMD is calculated based on target intake airflow GAIRCMD, target intake pressure PBACMD is calculated using target intake airflow GAIRCMD and target EGR flow GEGRCMD, target opening THCMD is calculated using target intake airflow GAIRCMD and target intake pressure PBACMD, and target lift amount LCMD is calculated using target EGR flow GEGRCMD and target intake pressure PBA. The throttle valve 3 and EGR valve 13 are controlled so that the throttle valve opening TH corresponds to the target opening THCMD and the lift amount LACT corresponding to the actual opening of the EGR valve 13 corresponds to the target lift amount LCMD.

In FIG. 2, an operation example is shown in which the target torque TRQCMD reduces in a step shape at time t1 and increases in a step shape at time t2. Such change of target torque TRQCMD occurs by a torque change request from the transmission control ECU when upshifting is performed, for example, in the transmission.

In this example, target intake airflow GAIRCMD, target EGR flow GEGRCMD, and target intake pressure PBACMD change in the same manner as target torque TRQCMD and therefore, target opening THCMD and target lift amount LCMD also changes as is the case with target torque TRQCMD, but as for actual intake airflow GAIR, EGR flow GEGR, and intake pressure PBA, as shown by a broken line, the change is delayed. Now, as is obvious from the comparison between (b) and (c) of FIG. 2, the change delay of the EGR flow GEGR is larger than that of the intake airflow GAIR. Therefore, as shown by an arrow A, overshoot of the intake airflow GAIR occurs and temporary increase of the engine output torque, that is, a torque shock has occurred.

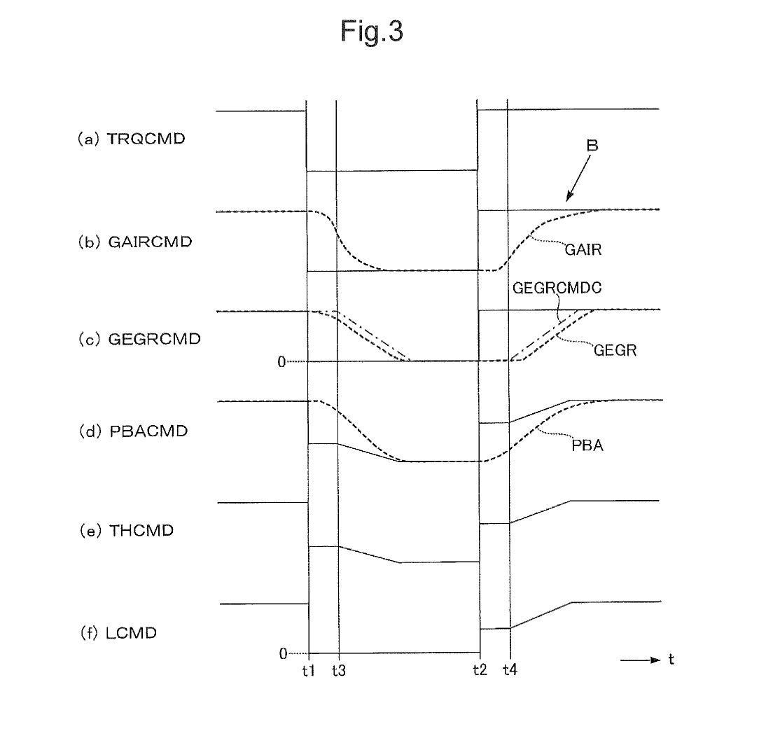

FIG. 3 is a time chart for explaining a control method in the present embodiment, wherein (a) to (f) of FIG. 3 show a transition of the same control parameter as the corresponding (a) to (f) of FIG. 2. However, (d) of FIG. 3 shows a transition of the target intake pressure PBACMD calculated using the correction target EGR flow GEGRCMDC (shown by a chain line in (c) of FIG. 3) calculated by performing a change delay process (hereinafter referred to as “EGR change delay process”) with regard to the target EGR flow GEGRCMD.

The transition shown by a solid line in (a) to (c) of FIG. 3 is the same as that of (a) to (c) of FIG. 2, but as for the target intake pressure PBACMD shown in (d) of FIG. 3, a change amount in time t1 and t2 decreases, it is maintained at the same value for a period from time t1 to time t3 and from time t2 to time t4, gradually decreases after time t3, while it gradually increases after time t4 to transitions until its original target value. Accordingly, the target opening THCMD and the target lift amount LCMD calculated using the target intake pressure PBACMD are controlled to show the same change mode as the target intake pressure PBACMF. However, FIG. 3 shows an operation example in which, in time t1, the target EGR flow GEGRCMD becomes “0” and, in time t1, the target lift amount LCMD becomes “0” (refer to the formula 6).

The target intake pressure PBACMD, in the conventional example shown in FIG. 2, changes as is the case with the target intake airflow GAIRCMD and the target EGR flow GEGRCMD, but in the present embodiment, correction target EGR flow GEGRCMDC is calculated by performing the EGR change delay process with regard to the target EGR flow GEGRCMD and the target intake pressure PBACMD is calculated using the target intake airflow GAIRCMD and correction target EGR flow GEGRCMDC. The correction target EGR flow GEGRCMDC calculated by performing the EGR change delay process corresponds to the change delay of actual recirculated exhaust flow GEGR, wherein by calculating the target intake pressure PBACMD using the correction target EGR flow GEGRCMDC, target intake pressure PBACMD in which change delay process (hereinafter referred to as “PBA change delay process”) corresponding to the change delay of the recirculated exhaust flow GEGR was performed can be obtained.

Accordingly, by calculating the target opening THCMD using the target intake pressure PBACMD calculated by performing PBA change delay process and target intake airflow GAIRCMD, the change of target opening THCMD is accompanied by the change delay corresponding to the change delay of actual EGR flow GEGR and, as shown by an arrow B in FIG. 3(b), overshoot of actual intake airflow GAIR can be removed.

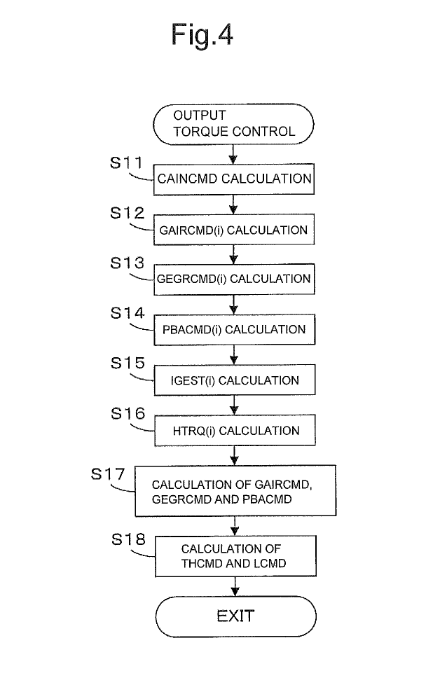

FIG. 4 is a flow chart for performing an output torque control of the engine 1 described above. This process is performed in the ECU 5 at each prescribed time TCAL (e.g., 10 msec).

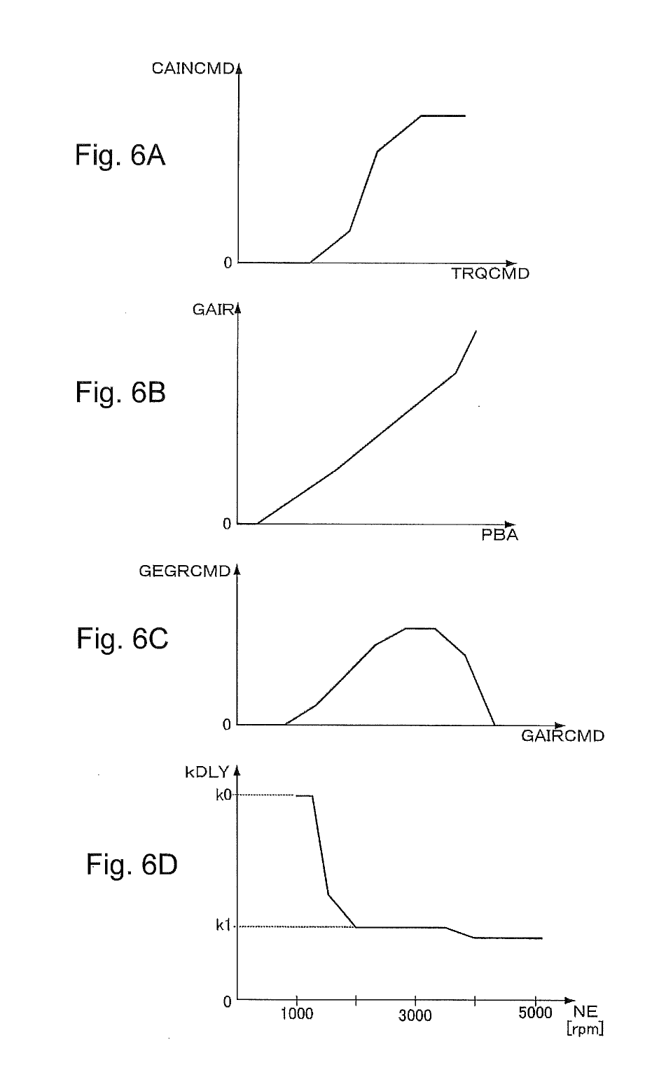

In step S11, CAINCMD map is searched according to target torque TRQCMD to calculate a target operation phase CAINCMD. The target operation phase CAINCMD is a target value of an intake valve operation phase CAIN and is set so that, according to the target torque TRQCMD, for example, as shown in FIG. 6A, the intake valve operation phase CAIN increases in general as the target torque TRQCMD increases. The intake valve operation phase CAIN is defined as an advance quantity and is set so that the intake valve operation phase CAIN increases (advances) as the target torque TRQCMD increases. An engine speed NE is also considered in the event of calculation of the intake valve operation phase CAIN and the intake valve operation phase CAIN is set to decrease (is delayed) as the engine speed NE increases.

In step S12, 10 supposed target intake airflows GAIRCMD (i) (i=0˜9) according to the target operation phase CAINCMD are calculated. In other words, supposed target intake airflow GAIRCMD (0) corresponding to a state in which the intake pressure PBA IS “0”, supposed target intake airflow GAIRCMD (9) corresponding to a state in which the intake pressure PBA is equivalent to the atmospheric pressure PA, and supposed intake airflow GAIRCMD (1)˜GAIRCMD (8) located therebetween at regular intervals are calculated. In the case of calculation of the target intake airflow GAIRCMD according to the intake pressure PBA, GAIR map set, for example, as shown in FIG. 6B is used. FIG. 6B shows the relation corresponding to a state in which the intake valve operation phase CAIN and the engine speed NE are constant, wherein the intake airflow GAIR increases as the engine speed NE is faster and the intake valve operation phase CAIN increases.

In the present embodiment, 10 supposed target EGR flow GEGRCMD (i), 10 supposed target intake pressure PBACMD (i), 10 supposed ignition timing IGEST (i), and 10 estimated output torque HTRQ (i) are calculated (step S13˜S16) in response to 10 supposed target intake airflows GAIRCMD (i) (i=0˜9) calculated in step 12 and the target intake airflow GAIRCMD, the target EGR flow GEGRCMD, and the target intake pressure PBACMD are calculated (step S17) based on the relation between the target torque TRQCMD and estimated output torque HTRQ (i) and 10 supposed target intake airflows GAIRCMD (i).

In step S13, in response to tentative target intake airflow GAIRCMD (i) (i=0˜9), tentative target EGR flow GEGRCMD (i) (i=0˜9) is calculated. Applied to this calculation is, for example, the relation shown in FIG. 6C (in which the engine speed NE is constant). In an intake airflow range in which EGR is performed, the target EGR flow GEGRCMD is set to reduce as the engine speed NE increases.

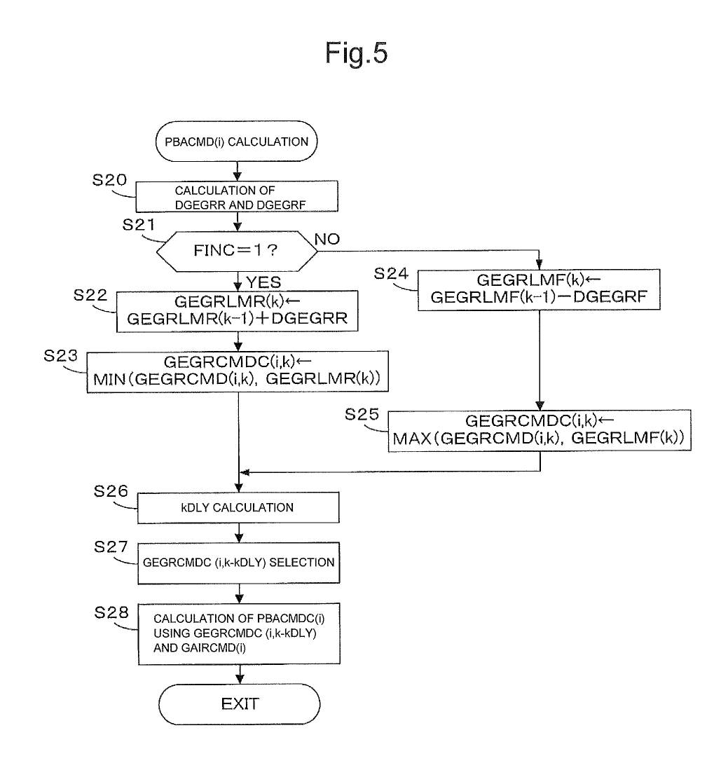

In step S14, by performing the processes shown in FIG. 5 described later, the tentative target intake pressure PBACMD (i) (i=0˜9) is calculated using the tentative target intake airflow GAIRCMD (i) and the tentative target EGR flow GEGRCMD (i) (i=0˜9).

In step S15, considering the delayed correction amount according to an occurring state of knocking as well as the tentative target intake airflow GAIRCMD (i), the tentative target intake pressure PBACMD (i) (i=0˜9) and the engine speed NE, the tentative ignition timing IGEST (i) (i=0˜9), using known methods, is calculated.

In step S16, estimated output torque HTRQ (i) (i=0˜9) of the engine 1 is calculated, using the known methods, using the tentative target intake airflow GAIRCMD (i), the tentative target intake pressure PBACMD (i) and tentative ignition timing IGEST (i) (i=0˜9).

In step S17, by performing the following interpolation calculation, the target intake airflow GAIRCMD, the target EGR flow GEGRCMD and the target intake pressure PBACMD are calculated.
1) Determine a value iX of an index parameter that meets the following relation (iX is an integer value between “0” and “8”.)

HTRQ(iX)≤TRQCMD<HTRQ (iX+1)
2) Calculate an interpolating rate KINT by the following formula (1).

KINT=(TRQCMD−HTRQ (iX))/(HTRQ (iX+1)−HTRQ (ix)) (1)
3) Calculate target intake airflow GAIRCMD, target EGR flow GEGRCMD and target intake pressure PBACMD.

GAIRCMD=GAIRCMD (iX)+KINT×(GAIRCMD (iX+1)−GAIRCMD (ix)) (2)

GEGRCMD=GEGRCMD (iX)+KINT×(GEGRCMD (iX+1)−GEGRCMD (iX) (3)

PBACMD=PBACMD (iX)+KINT×(PBACMD (iX+1)−PBACMD (iX)) (4)

In step S18, using the following formulas (5) and (6) known as a nozzle formula, calculate an effective opening area ATHCMD of a nozzle valve 3 and an effective opening area ALCMD of the EGR valve 13 and convert the effective opening area ATHCMD and ALCMD to a target opening THCMD and target lift amount LCMD respectively using a predetermined conversion table.

$$\begin{matrix}[ formula 1 ] & \\ ATHCMD = \frac{\sqrt{R \times TAK} \times GAIRCMD}{KC \times PA \times φ ( \frac{PBACMD}{PA} )} & ( 5 ) \\ ALCMD = \frac{\sqrt{R \times TEXK} \times GEGRCMD}{KC \times PEX \times φ ( \frac{PBACMD}{PEX} )} & ( 6 )\end{matrix}$$

Now, R is a gas constant, TAK and TEXK are intake air temperature and exhaust (gas) temperature which are shown in the absolute temperature, PA and PEX are atmospheric pressure and exhaust pressure to be recirculated, KC is a constant for unit conversion, Ψ is a pressure ratio flow function. As for the exhaust temperature TEXK, a temperature estimated using a map set according to the engine speed NE and the intake airflow GAIR is applied and as for the exhaust pressure PEX, a pressure value estimated using a pressure loss PLS1 from a muffler of a vehicle 100 to an inlet of the EGR passage 12 and a pressure loss PLS2 in the EGR passage 12 is applied. The pressure loss PLS1 is calculated using the map set according to the engine speed NE and the intake airflow GAIR, while the pressure loss PLS2 is calculated using the map set according to the engine speed NE and the EGR flow GEGR. Each estimation method of the exhaust temperature TEXK and the exhaust pressure PEX is known.

FIG. 5 is a flow chart of a PBACMD (i) calculation process performed in step S14 of FIG. 4.

In step S20, an amount of increase DGEGRR and a decrease DGEGRF which are applied to the calculation of step S22 and step S24 in a rate limit process are calculated according to the engine speed NE. The amount of increase DGEGRR and the decrease DGEGRF are set to increase as the engine speed NE increase.

In step S21, it is judged whether or not a target EGR flow increase flag FINC is “1”. The target EGR flow increase flag FINC is set to “1” when a sign of an amount of change DGEGR defined the following formula (7) is positive, is maintained to “1” when the amount of change DGEGR is “0” or more, while if it is negative, FINC is changed to “0” and is maintained to “0” if the sign is less than “0” and thereafter is changed to “1” when the sign is positive.

DGEGR=GEGRCMD (k)−GEGRCMD (k−1) (7)

Now, k is a discrete time discretized in the operation period (TCAL) of the present process.

If the answer of step S21 is Yes, in other words, the target EGR flow increase flag FINC is “1”, the amount of increase DGEGRR calculated in step S20 is applied to the following formula (8) to calculate increased rate limit value GEGRLMR (k) (step S22).

GEGRLMR (k)=GEGRLMR (k−1)+DGEGRR (8)

Now, the initial value of increased rate limit value GEGRLMR (k) is set to “0”.

In step S23, the increases rate limit value GEGRLMR (k) calculated in this way and the tentative target EGR flow GEGRCMD (i, k) are applied to the following formula (9) to calculate tentative correction target EGR flow GEGRCMDC (i, k). The formula (9) corresponds to the limit process selecting the smaller one of GEGRCMD (i, k) and GEGRLMR (k) as the tentative correction target EGR flow GEGRCMDC (i, k).

GEGRCMDC (i, k)=MIN (GEGRCMD (i, k), GEGRLMR (k)) (9)

If the answer of step S21 is NO, in other words, the target EGR flow increase flag FINC is “0”, the decrease DGEGRF calculated in step S20 is applied to the following formula (10) to calculate the decrease rate limit value GEGRLMF (k) (step S24).

GEGRLMF (k)=GEGRLMF (k−1)−DGEGRF (10)

Now, the initial value of the decrease rate limit value GEGRLMF (k) is set to “0”.

In step S25, the decrease rate limit value GEGRLMF (k) calculated in this way and the tentative target EGR flow GEGRCMDC (i, k) are applied to the following formula (11) to calculate tentative correction target EGR flow GEGRCMDC (i, k). The formula (11) correspond to a limit process selecting larger one of GEGRCMD (i, k) and GEGRLMF (k) as the tentative correction target EGR flow GEGRCMDC (i, k).

GEGRCMD (i, k)=MAX (GEGRCMD (i, k), GEGRLMF (k)) (11)

The tentative correction target EGR flow GEGRCMDC (i,k) (i=0˜9) calculated in step 23 and step 25, to perform the dead time corresponding delay process, is provided to store the calculated value in a period corresponding to the maximum dead time (e,g., a calculated value corresponding from (k−1) to (k−20) in the discrete time). Thus, the tentative correction target EGR flow GEGRCMDC (i, k) to which rate limit process controlling the amount of change per unit time were performed by steps S21 to S25) is obtained.

In step S26, by searching kDLY table shown in FIG. 6D according to the engine speed NE, discrete dead time kDLY discretizing the dead time by an operation period TCAL is calculated. The kDLY table, in general, is set to decrease the discrete dead time kDLY as the engine speed NE increases. k0 and k1 of FIG. 6D is set to 20 (200 msec equivalent value) and 8 (80 msec equivalent value) respectively.

In step S27, by reading, from a buffer memory, GEGRCMDC (i, k-kDLY) that is the calculated value before discrete dead time calculated in step S26 (hereinafter referred to as “dead time process value”), tentative target intake pressure PBA CMD (i) (i=0˜9) is calculated using this dead time process value GEGRCMDC (i, K-kDLY) and tentative target intake airflow GAIRCMD (i) (Step S28).

Namely, after calculating the intake gas flow GGASIN using the following formula (12), the tentative target intake pressure PBACMD (i) is calculated using the relation shown in FIG. 6B.

GGASIN=GAIRCMD (i)+GEGRCMDC (i,k-kDLY) (12)

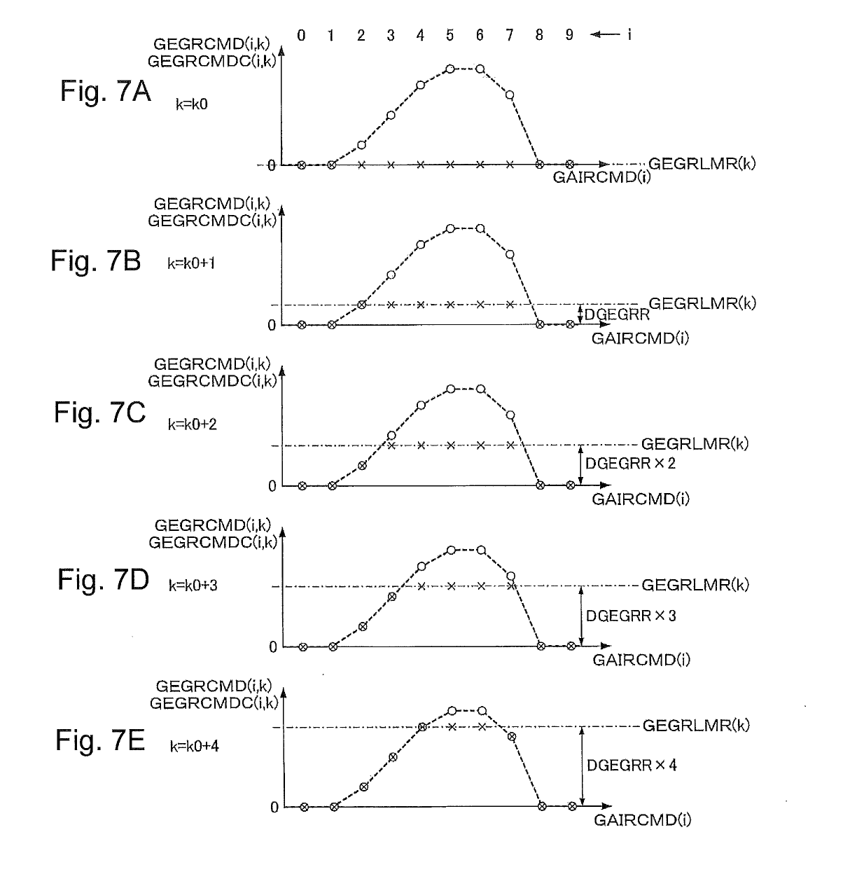

FIGS. 7A to 7E are views for explaining the rate limit process in the increasing direction by step S22 and step S23 of FIGS. 6A to 6D, wherein FIGS. 7A to E show a transition of the tentative correction target EGR flow GEGRCMDC (i) (shown by “x”) for a period from k0 to (k0+4) of a discrete time k. We are assuming that the engine speed NE is maintained almost constant, wherein the tentative target EGR flow GEGRCMD (i) before correction is shown by “o”.

In time k0, the increase rate limit value GEGRLMR (k0) is “0”, and tentative correction target EGR flow GEGRCMDC (i) (i=0˜9) becomes always “0”. In time (k0+1), the tentative correction target EGR flow GEGRCMDC (i) (i=3˜7) is limited to the increase rate limit value GEGRLMR (k0+1) and in time (k0+2), tentative correction target EGR flow GEGRCMDC (i) (i=3˜7) is limited to the increase rate limit value GEGRLMR (k0+2), in time (k0+3), tentative correction target EGR flow GEGRCMDC (i) (i=4˜7) is limited to the increase rate limit value GEGRLMR (k0+3) and in time (K0+4), tentative correction target EGR flow GEGRCMDC (i) (i=5, 6) is limited to the increase rate limit value GEGRLMR (k0+4).

In this manner, in the present embodiment, by performing PBA change delay process corresponding to the change delay of the EGR flow GEGR by the EGR device, target intake pressure PBACMD is calculated and by using the target intake pressure PBACMD and the target intake airflow GAIRCMD, the target opening THCMD of the throttle valve 3 is calculated. Thus, the intake airflow control is performed in which the throttle valve opening TH changes associated with the delay corresponding to the change delay of the EGR flow GEGR. In this manner, it is possible to prevent the actual intake airflow GAIR from overshooting past the target intake airflow GAIRCMD and generating a torque shock resulting from the change delay of the EGR flow GEGR.

The target EGR flow GEGRCMD is calculated by using the target intake airflow GAIRCMD. Also, by performing EGR change delay process with regard to the target EGR flow GEGRCMD, correction target EGR flow GRGRCMD is calculated and the lift amount LACT of the EGR valve 13 is provided so that the EGR flow GEGR corresponds to the target EGR flow GEGRCMD and by calculating the target intake pressure PBACMD using the target intake airflow GAIRCMD and the correction target EGR flow GEGRCMDC, PBA change delay process is performed. Since the change delay of the EGR flow GEGR is reflected in the correction target EGR flow GEGRCMDC, by calculating the target intake pressure PBACMD using the correction target EGR flow GEGRCMDC and the target intake airflow GAIRCMD, it is possible to perform PBA change delay process corresponding to the change delay of the EGR flow GEGR. By calculating the target opening THCMD of the throttle valve 3 using the target intake pressure PBACMD calculated in this way, it is possible to set the target opening THCMD accompanied by the delay corresponding to the change delay of the recirculated exhaust flow GEGR.

Since the target lift amount LCMD of the EGR valve 13 is calculated based on the target EGR flow GEGRCMD and the target intake pressure PBACMD and the EGR valve 13 is controlled in such a manner that the lift amount LACT of the EGR valve 13 corresponds to LCMD, it is possible to change the lift amount LACT of the EGR valve 13 as is the case with the change characteristics of the throttle valve opening TH controlled using the target intake pressure PBACMD.

Further, as a change delay process of the target EGR flow GEGRCMD, since the dead time corresponding delay process (steps S26 and S27 in FIG. 5) corresponding to the dead time and a rate limit process (Steps S21 to S25 in FIG. 5) for limiting the change rate are performed and correction target EGR flow GEGRCMDC is calculated, it is possible to cause the change of correction target EGR flow GEGRCMDC to correspond to the change delay of actual EGR flow GEGR comparatively precisely.

Still further, the tentative target intake airflow GAIRCMD(i)(i=0˜9) corresponding to a plurality of candidate values of the target intake airflow GAIRCMD is calculated and an estimated output torque HTRQ (i)corresponding to the tentative target intake airflow GAIRCMD (i) calculated using tentative ignition timing IGEST (i) corresponding to the tentative target intake airflow GAIRCMD (i) and the target intake airflow GAIRCMD is calculated based on the relation between the estimated output torque HTRQ (i) and the target torque TRQCMD and the tentative target intake airflow GAIRCMD (i). Specifically, an index parameter value iX is determined from the relation of estimated output torque HTRQ (i) and the target torque TRQCMD and the target intake airflow GAIRCMD is calculated using the formula (1). Accordingly, the intake airflow control by adding the change of actual output torque TRQ depending on the setting of ignition timing is performed and it is possible to cause the actual output torque TRQ to correspond to the target torque TRQCMD with a high accuracy.

Also, though the control method of the present embodiment is applied even when the target torque TRQCMD suddenly reduces in the reducing direction (refer to FIG. 3, time t1˜t3), there is no drawback associated with this and the calculating methods of the target opening THCMD and the target lift amount LCMD described above can be always applicable. In the case where the target torque TRQCMD reduces in the reducing direction, though not shown in FIG. 2, there is a possibility that the intake airflow GAIR is temporarily lower than the target intake airflow GAIRCMD, thereby causing instability of combustion. According to the control method of the present embodiment, it is also effective for preventing such instability of combustion.

In the present embodiment, the ECU 5 comprises a target opening calculating means, part of a throttle valve driving means, a target torque calculating means, a target intake airflow calculating means, a target intake pressure calculating means, a target EGR flow calculating means, a correction target EGR flow calculating means, a flow control valve control means, and an estimated engine output torque calculating means, wherein an actuator 3a constitutes part of the throttle valve driving means.

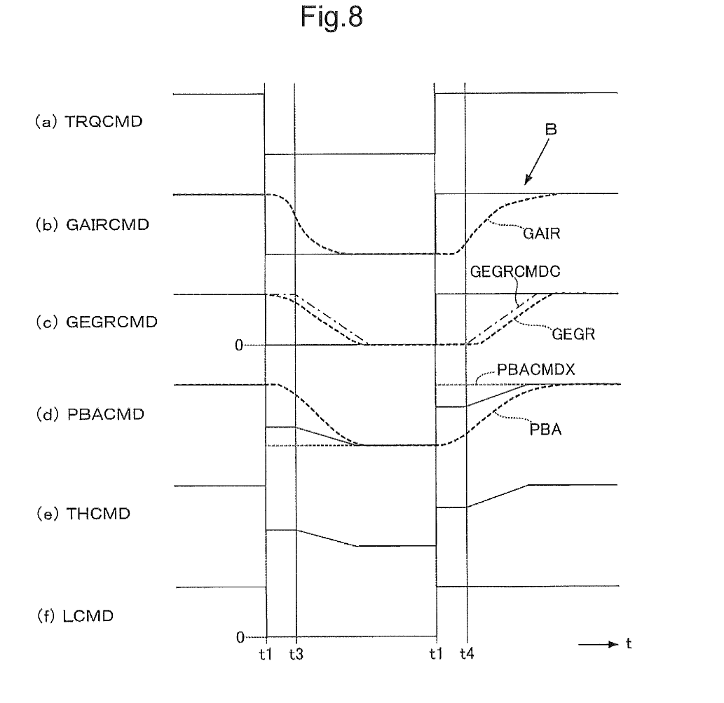

It is to be noted that the present invention is not limited to the embodiments described above, but various modifications and substitutions may be made. For example, the formula (6) for calculating an effective opening area ALCMD of the EGR valve 13 can be substituted by the following formula (6a). In the formula (6a), in place of a target intake pressure PBACMD which has performed the PBA change delay process, a target intake pressure PBACMDX without delay corresponding to a target intake pressure in which PBA change delay process has not been performed is applicable. Since a target lift amount LCMD is set as shown in (f) of FIG. 8, it is possible to reduce more the delay of the recirculated exhaust flow GEGR than the above embodiment. As shown in (d) of FIG. 8 by a fine broken line, it was confirmed that the target intake pressure PBACMDX changes in the same manner as the target torque TRQCMD.

$$\begin{matrix}[ formula 2 ] & \\ ALCMD = \frac{\sqrt{R \times TEXK} \times GEGRCMD}{KC \times PEX \times φ ( \frac{PBACMD}{PEX} )} & ( 6 a )\end{matrix}$$

In the above embodiment, a control device of an engine 1 provided with a valve operating characteristic variable device 40, but the present invention is also applicable to an engine control device without the valve operating characteristic variable device 40. Further, the present invention is applicable not only to an engine in which fuel is injected into a combustion chamber, but also to a control device for an engine in which fuel is injected into an intake passage. Still further, the present invention is applicable to a control device for an engine equipped with a supercharger and in this case, as for the pressure on the upstream side of the throttle valve in the formula (5), boost pressure PB is applied in place of atmospheric pressure PA.

According to the embodiment of the present invention, a control device for an internal combustion engine with an EGR device (12, 13) for recirculating exhaust gas to an intake passage (2) comprises a target opening calculating means for calculating a target opening (THCMD) of a throttle valve (3) housed in the intake passage, and a throttle valve driving means for driving the throttle valve (3) so that an actual opening (TH) of the throttle valve corresponds to the target opening (THCMD), wherein the control device further comprises a target torque calculating means for calculating a target torque (TRQCMD) of the engine, a target intake airflow calculating means for calculating a target intake airflow (GAIRCMD) of the engine based on the target torque (TRQCMD), and a target intake pressure calculating means for calculating a target intake pressure (PBACMD) based on the target intake airflow (GAIRCMD), wherein the target intake pressure calculating means calculates the target intake pressure (PBACMD) by performing an intake pressure change delay process corresponding to the change delay of EGR flow (GEGR) that is a flow of exhaust to be recirculated through the EGR device; the target opening calculating means calculates the target opening (THCMD) using the target intake airflow (GAIRCMD) and the target intake pressure (PBACMD).

According to this constitution, since a target intake pressure is calculated by performing intake pressure change delay process corresponding to the change delay of the EGR flow by EGR device and a target opening of the throttle valve is calculated using the target intake pressure and a target intake airflow, an intake airflow control is performed that a throttle valve opening changes with a delay corresponding to a change delay of EGR flow. As a result, it is possible to prevent the actual intake airflow from overshooting past the target intake airflow and generating a torque shock resulting from the change delay of the EGR flow.

The control device for the internal combustion engine may comprise a target EGR flow calculating means for calculating a target EGR flow (DEGRCMD) based on the target intake airflow (GAIRCMD), a correction target EGR flow calculating means for calculating a correction target EGR flow (GEGRCMDC) by performing a EGR flow change delay process with regard to the correction target EGR flow (GEGRCMDC), and a flow control valve control means for controlling an opening of a EGR flow control valve (13) housed in the EGR device so that the EGR flow (GEGR) corresponds to the target EGR flow (GEGRCMD), wherein the target intake pressure calculating means calculates the target intake pressure (PBACMD) using the target intake airflow (GAIRCMD) and the correction target EGR flow (GEGRCMDC), thereby performing the intake pressure change delay process.

According to this constitution, the target EGR flow is calculated using the target intake airflow, the correction target EGR flow is calculated by performing the EGR flow change delay process with regard to the target EGR flow, the opening of the EGR flow control valve is controlled so that the EGR flow corresponds to the target EGR flow, and the target intake pressure is calculated using the target intake airflow and the correction target EGR flow, whereby the intake pressure change delay process can be performed. Since the change delay of the EGR flow is reflected in the correction target EGR flow, it is possible to perform the intake pressure change delay process corresponding to the change delay of the EGR flow by calculating the target intake pressure using the correction target EGR flow and the target intake airflow. By calculating the target opening of the throttle valve using the target intake pressure calculated in this manner, setting of the target opening accompanied by the delay corresponding to the change delay of the recirculated exhaust flow is made possible.

The control device for the internal combustion engine may be provided in such a manner that the flow control valve control means controls the opening of the EGR flow control valve (13) based on the target EGR flow (GEGRCMD) and the target intake pressure (PBACMD).

According to this constitution, since the opening of the EGR flow control valve is controlled based on the target EGR flow and the target intake pressure, the opening of the EGR flow control valve can be changed in the same manner as the change characteristics of a throttle valve opening controlled using the target intake pressure.

The control device for the internal combustion engine may be provided in such a manner that the EGR flow change delay process includes the delay process (S26, S27) corresponding to the dead time and the rate limit process (S21˜S25) limiting a change rate.

According to this constitution, as the EGR flow change delay process, since the delay process corresponding to the dead time and the rate limit process limiting the change rate, it is possible to cause the change of correction target EGR flow to correspond to the change delay of actual EGR flow comparatively precisely.

The control device for the internal combustion engine may be provided in such a manner that the target intake airflow calculating means comprises a candidate value calculating means for calculating a plurality of candidate values (GAIRCMD(i)) of the target intake airflow and an estimated engine output torque value calculating means for calculating a plurality of estimated engine output toque values (HTRQ(i)) corresponding to the plurality of candidate values (GAIRCMD (i)), using a plurality of supposed ignition timing (IGEST(i)) of the engine, corresponding to the plurality of candidate values (GAIRCMD(i)), wherein the target intake airflow (GAIRCMD) is calculated based on the relationship between the estimated engine output torque value (HTRQ(i)) and the target torque (TRQCMD) and on the plurality of candidate values (GAIRCMD (i)).

According to this constitution, a plurality of candidate values of the target intake airflow are calculated and a plurality of estimated engine output torque values corresponding to a plurality of candidate values are calculated using a plurality of supposed ignition timing corresponding to a plurality of candidates, wherein the target intake airflow is calculated, based on the relationship between the estimated engine output torque value and the target torque and on a plurality of candidate values. Accordingly, the intake airflow control is performed by adding the change of actual output torque depending on the setting of ignition timing, wherein it is possible to cause the actual output torque to correspond to the target torque with a high accuracy.

Obviously, numerous modifications and variations of the present invention are possible in light of the above teachings. It is therefore to be understood that within the scope of the appended claims, the invention may be practiced otherwise than as specifically described herein.

What is claimed is:

1. A control device for an internal combustion engine provided with an exhaust gas recirculation device adapted to recirculate exhaust gas to an intake passage comprising:
target opening calculating means for calculating a target opening of a throttle valve housed in the intake passage; and
throttle valve driving means for driving the throttle valve so that the actual opening of the throttle valve corresponds to the target opening;
the control device further comprising:
target torque calculating means for calculating a target torque of the engine;
target intake airflow calculating means for calculating a target intake airflow of the engine based on the target torque; and
target intake pressure calculating means for calculating a target intake pressure based on the target intake airflow, wherein
the target intake pressure calculating means calculates the target intake pressure by performing an intake pressure change delay process corresponding to a change delay of recirculated exhaust flow that is a flow of exhaust to be recirculated through the exhaust gas recirculation device, and
the target opening calculation means calculates the target opening using the target intake airflow and the target intake pressure.

2. The control device for the internal combustion engine according to claim 1 comprising:
target recirculated exhaust flow calculating means for calculating a target recirculated exhaust flow based on the target intake airflow;
correction target recirculated exhaust flow calculating means for calculating a correction target recirculated exhaust flow by performing a recirculated exhaust flow change delay process with respect to the target recirculated exhaust flow; and
flow control valve control means for controlling an opening of a recirculated exhaust flow control valve provided in the exhaust gas recirculation device so that the recirculated exhaust flow corresponds to the target recirculated exhaust flow, wherein
the target intake pressure calculating means calculates the target intake pressure using the target intake airflow and the correction target recirculated exhaust flow, thereby performing the intake pressure change delay process.

3. The control device for the internal combustion engine according to claim 2, wherein the flow control valve control means controls the opening of the recirculated exhaust flow control valve based on the target recirculated exhaust flow and the target intake pressure.

4. The control device for the internal combustion engine according to claim 2, wherein the recirculated exhaust flow change delay process includes a delay process corresponding to dead time and a rate limit processing for limiting a change rate.

5. The control device for the internal combustion engine according to claim 1, wherein the target intake airflow calculating means comprises:
candidate value calculating means for calculating a plurality of candidate values of the target intake airflow; and
estimated engine output torque value calculating means for calculating a plurality of estimated engine output torque values corresponding to the plurality of candidate values using a plurality of supposed ignition timing of the engine corresponding to the plurality of candidate values, wherein
the target intake airflow is calculated based on the relationship between the estimated engine output torque value and the target torque, and on the plurality of candidate values.

6. A control device for an internal combustion engine, comprising:
a throttle valve actuator to drive a throttle valve provided in an intake passage in the internal combustion engine; and
circuitry configured to
calculate a target torque to be generated by the internal combustion engine,
calculate a target intake air amount of the internal combustion engine based on the target torque,
calculate, based on the target intake air amount, a target recirculated amount of recirculated exhaust gas that is recirculated to the intake passage through an exhaust gas recirculation device of the internal combustion engine,
calculate a corrected target recirculated amount based on the target recirculated amount and an exhaust gas recirculation amount change delay in a change in a recirculated amount of the recirculated exhaust gas,
calculate a target intake pressure based on the target intake air amount and the corrected target recirculated amount,
calculate a target opening degree of the throttle valve based on the target intake air amount and the target intake pressure, and
control the throttle valve actuator to drive the throttle valve such that an opening degree of the throttle valve is to be equal to the target opening degree.

7. The control device according to claim 6, wherein the circuitry is configured to control an opening degree of a recirculated exhaust air amount control valve provided in the exhaust gas recirculation device such that the recirculated amount of the recirculated exhaust gas is to be equal to the target recirculated amount.

8. The control device according to claim 7, wherein the circuitry is configured to control the opening degree of the recirculated exhaust air amount control valve based on the target recirculated amount and the target intake pressure.

9. The control device according to claim 6, wherein the circuitry is configured to perform a delay process corresponding to dead time and a rate limit process for limiting a change rate in order to calculate the corrected target recirculated amount.

10. The control device according to claim 6, wherein the circuitry is configured to
calculate a plurality of candidate values of the target intake air amount; and
calculate a plurality of estimated engine output torques corresponding to the plurality of candidate values based on a plurality of supposed ignition timing of the internal combustion engine corresponding to the plurality of candidate values,
wherein the circuitry is configured to calculate the target intake air amount based on a relationship between the plurality of estimated engine output torques and the target torque, and on the plurality of candidate values.

11. A method for controlling an internal combustion engine, comprising:
calculating a target torque to be generated by the internal combustion engine,
calculating a target intake air amount of the internal combustion engine based on the target torque,
calculating, based on the target intake air amount, a target recirculated amount of recirculated exhaust gas that is recirculated to an intake passage in the internal combustion engine through an exhaust gas recirculation device of the internal combustion engine,
calculating a corrected target recirculated amount based on the target recirculated amount and an exhaust gas recirculated amount change delay in a change in a recirculated amount of the recirculated exhaust gas,
calculating a target intake pressure based on the target intake air amount and the corrected target recirculated amount,
calculating a target opening degree of a throttle valve provided in the intake passage based on the target intake air amount and the target intake pressure, and
driving the throttle valve such that an opening degree of the throttle valve is to be equal to the target opening degree.
